(19) United States
(12) Patent Application Publication
(10) Pub. No.: US 2024/0405343 A1
(43) Pub. Date: Dec. 5, 2024

(54) RESIDENTIAL BATTERY SYSTEM

(71) Applicant: Neubau Energy Inc, San Anselmo, CA (US)

(72) Inventors: Michael John Okoniewski, San Rafael, CA (US); Thomas Enzendorfer, San Anselmo, CA (US)

(21) Appl. No.: 18/679,319

(22) Filed: May 30, 2024

Related U.S. Application Data
(60) Provisional application No. 63/505,141, filed on May 31, 2023.

(51) Int. Cl. H01M 50/271; H01M 50/244; H01M 50/284; H02J 7/00

(52) U.S. Cl. CPC H01M 50/271; H01M 50/244; H01M 50/284; H02J 7/0013; H02J 2300/24; H02J 2300/28

(57) ABSTRACT

A battery system, comprising: a power storage module; a curved cover; a battery pivot system; wherein said power storage module is replaceable; wherein said curved cover is configured to receive a printed material; wherein said battery pivot system is configured to allow access to one or more components of the battery system by rotating down about 90 degrees.

### CROSS-REFERENCE TO RELATED APPLICATION

This Application is a U.S. Non-Provisional Patent Application that claims the benefit of, and priority to, U.S. Provisional Patent Application No. 63/505,141, filed on May 31, 2023, titled “RESIDENTIAL BATTERY SYSTEM” the contents of which are expressly incorporated herein by this reference as though set forth in its entirety and to which priority is claimed.

### FIELD OF DISCLOSURE

The present disclosure relates to a battery system for residential, commercial, and marine use. More specifically, the present disclosure relates to a battery storage system that may be installed by a single technician, is modular and expandable, and is aesthetically pleasing.

### BACKGROUND

Home battery systems, designed for the purpose of storing energy derived from renewable sources, such as solar panels or wind turbines, have become increasingly popular as a means of providing backup power during outages and reducing energy bills. These systems capture and store excess energy generated during periods of high production, making it available for use when renewable sources are not actively generating power.

Battery systems prior to the present disclosure are unsightly, heavy, difficult to install, require more than one technician to install, and/or are unable to be upgraded or modified as the user's needs change over time. Thus, what is needed is a battery storage solution that is aesthetically pleasing, easy to install, and modular for future use.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a dynamic supervisory system for solar and energy storage projects.

One embodiment of the battery system of the present disclosure may address the shortcomings of existing products. The battery system may be modular to lighten the weight of each part to make it manageable and installable by a single technician. The battery system may also be affordable, have a visually appealing design, have a plug and play type contact system, include a flexible curved LED display module (LDM), and charging port receiver modules.

The mounting devices of the battery system may comprise a housing and a plurality of fasteners. The housing may be a single unit that may be configured to contain all of the components necessary to mount a wall unit. The fasteners may be used to secure the housing to a wall.

The mounting system may be installed by first attaching the housing to the wall using the fasteners. The wall unit may then be placed in the housing and secured in place. The mounting system may be a simple and effective way to install wall units. In some embodiments, this may eliminate the need for multiple parts, which makes installation easier and less frustrating. The mounting system may be designed to affix the housing to a wall or other structure and, due to its design, may enable multiple mounting positions from 0 to 180 degrees and the unit is designed to also be mounted in various positions on a floor mount, while the housing stores the batteries. In other embodiments, the mounting position may be any degree desired. This design may allow for installation and service by one person possible while providing redundancy to the overall system. These modular batteries may be engineered to be weight conscious to be able to be installed by one person. In alternate embodiments, heavier batteries may utilize weight lessening systems to aid installation. These modules may store energy originating from various generating sources, including but not limited to renewable sources. The inverter's function is to convert this stored energy into alternating current (AC) power, while the control module oversees the system's overall operation.

The battery system sets itself apart from existing solutions in several ways:
(1) Hinged workstation: The battery may feature hinges that allow it to be lowered to a 90-degree angle and locked in place, creating a convenient workstation for installers during installation or servicing.
(2) Customizable front panel: The modular curved front panel, which is sometimes referred to as the facia, which may preferably be made from any renewable material and can be digitally printed upon or painted, may enable users to create a custom appearance that blends seamlessly with their home's exterior creating a truly decorative and architectural element. This system may also include a flexible curved LED display module (LDM) on the front panel. This feature may allow information to be transferred to the panel displaying information for system or entertainment purposes. The front panel enclosure structure may be designed for multiple purposes, such as allowing the system to have better airflow and cooling properties, aiding in the displacement of water due to the curvature and placement of vents, the curve also facilitates other powered devices such as a speaker or lighting elements/components.
   a. In one embodiment, neodymium magnets may be impregnated into the front fascia, this allows the decorative front facia to be removeably connected to the front the chassis. Although not limited to magnets, magnets may be the preferred method of attachment. This creates the ability to install and remove the decorative front fascia, much easier and efficiently than clipping it, or screwing it to the chassis facia. Also, by adding the embedded magnets, the fascia may have a much cleaner and finished look when installed. The magnetized front facia may be available to the consumer as an add on item.
   b. The magnetized front facia may be custom made to order architectural element may enhance the look of the modular battery unit, and also give the consumer the ability to customize and create something unique to their unit. The facia, and it's customizability, is how the user may color match or match the siding style on their house or mounting location. Thus, if a customer has wood siding on their home, the facia can include a custom print of a photo of that wood siding or any desired graphic onto the extra fascia so when you mount this onto the unit it blends into the background and the general environment. This can be especially important for homeowner association or apartment complexes that have stringent rules. The facia allows the modular battery system to have a more architectural and creative solution.
(3) IP65-rated components: The modular batteries and the inverters may be IP65 rated, which may aid in protection against dust and water ingress and contributing to the entire system's IP65 rating. IP stands for Ingress Protection, and the digits “65” describe the exact degree of protection against contact and the ingress of foreign bodies (6) as well as water (5).
(4) Seamless cover design: The curved front panel may protrude six (6) inches on each side, creating a seamless cover that hides the connecting conduits when multiple batteries are connected. In other embodiments, the overhang may be different or asymmetrical, depending on the outward appearance (design) that is desired. The design may solve the unsightly appearance of an incoming conduit (or wiring) or a conduit (or wiring) connecting multiple storage units together by extending over the enclosure and when multiple units are mounted together, hiding the conduit that runs behind the units. Thereby creating an elegant solution to an overlooked problem. With home energy solutions becoming more popular, visual appeal, including hiding unsightly conduits connecting multiple units, will become more important to homeowners.
(5) Plug-and-play modular components: All batteries and inverters may be housed in cassettes with true plug-in plugs, simplifying installation and service while eliminating the need for wiring or rewiring.
(6) Enhanced airflow: The curved shape of the battery enclosure allows for better airflow, which may reduce heat and increase the longevity of the battery. The front panel of the enclosure structure may be curved as well in order to allow for adequate space for various components. In an alternate embodiment, the front panel may be flat.
(7) Versatile mounting options: The batteries may be ground-mounted with an inverter stand or wall-mounted at various angles (e.g., 90 degrees, 45 degrees, 180 degrees), creating a visually appealing “wave” effect when multiple batteries are daisy-chained together.

The battery system's mounting bracket and housing may form a single unit, simplifying installation. The system's modular design allows for scalability, accommodating users with varying energy needs. The individual components of the system may be IP65 rated, aiding in protection against dust and water ingress. The system may also be constructed from eco-friendly materials, including renewable bamboo. The battery system may feature an elegant design, with a curved bamboo composite front panel that imparts a sleek, modern appearance.

Regarding installation, the installer first locates the studs that are appropriate for the mounting of the battery chassis and mounting plate/wall bracket. The next step is to mount the wall bracket on the studs. Third, a single person may lift the chassis into place onto the wall bracket. After the fasteners are screwed into the studs through the chassis and mounting bracket the unit is now secured. The next step is wiring the chassis and control box. Then, the technician is able to lift the batteries, by themselves) and slide them into position and click them into place with the transfer power rod. The same slide and click procedure is then done with the inverters. Once these steps are complete the fascia/front plate cover is installed by magnetically clicking it in place.

Additionally, the mounting pad, which may become an integrated part of the unit that facilitates the true plug and play system for the control modules, battery modules, and all electrical connections may be pre-wired and therefore create an integrated wiring harness. The battery pivot system may take the load of the battery modules and distribute it to the back of the housing while allowing for multiple units to be installed side by side and still allow access to these from the front. A battery pivot system (BPS) may be used to pivot out each battery to facilitate easy access for installation and service by one technician.

In one embodiment, the battery system may include individual IP65 rated components, which may allow the battery system to provide ample and true passive cooling and airflow, thereby extending the life of the components and saving money and maintenance time.

In another embodiment, the mounting pad may come pre-wired with the required plugs, which may allow the utilization of the inverter space from the primary unit to become a battery module space in the secondary unit. The housing unit may be one single piece that is both the housing and the back (mounting) bracket together. The mounting pad may be a thin pad that facilitates the electrical and physical connections, the wiring, and allows for a true plug and play system. The individual components may be connected with a plug-in system thereby creating a water and dustproof connection. The battery pivot system (BPS) may be an integral part of the housing unit. The battery modules may communicate with the brain (controller unit) and the integrated battery management system (BMS) through the wiring pad and charge and/or discharge through the integrated power conversion system. Communication and interconnection systems may be integrated within the unit to allow for whole home monitoring in addition to the control of the battery system.

The battery system may comprise a stamped and welded housing unit, an injection molded electrical mounting pad, mounts, battery modules in cassette style, pivot rod, inverters, charge controller, data processing unit, fan, LED lights, and panels. The housing and mounting may be a single unit and the design of the front panel preferably allows for superior airflow and cooling without compromising IP65 rating and increases longevity. The front panel may be injection molded from renewable materials. By having components that can be 3D printed and/or molded, users can replace the modular setup with larger components, including larger batteries, and/or even add more components and batteries.

The battery system may be characterized by its case of installation, affordability, visually appealing design, and innovative features such as a modular and contact system, a flexible curved LED display module (LDM), and charging port receiver modules.

The mounting system may comprise a housing and a plurality of fasteners. The housing may be a single unit that contains all of the components necessary to mount a wall unit. Fasteners, such as screws and bolts, may be used to secure the housing to the wall.

The mounting system may be installed by first attaching the housing to the wall using the fasteners. The wall unit may then be placed in the housing and secured in place.

The mounting system may be a simple and effective way to install wall units. This eliminates the need for multiple parts, which makes it easier to install and less frustrating. The mounting system may be designed to affix the housing to a wall or other structure and, due to its unique design, enables multiple mounting positions from 0 to 180 degrees and the unit may be designed to also be mounted in various positions on a floor mount, while the housing stores the batteries. Making installation and service by one person possible while providing redundancy to the overall system. The modular batteries are engineered to be weight conscious (less than fifty (50) pounds) to be able to be installed by one person. The batteries may store energy originating from various generating sources, including but not limited to renewable sources (solar, wind, and the like). The inverter's function may be to convert the energy stored in the batteries into alternating current (AC) power, while the control module oversees the system's overall operation. In some installations, the battery power may be back-up to normal power that goes out.

The housing may include a chassis enclosure, which may be designed to support various components that plug into the enclosure, including but not limited to the battery or batteries, the inverter or inverters, the control modules, or any other device needed for the device to function. The modular design, quick connect/disconnect features, and contact system allow for easy installation and removal of components without the need for screws, brackets, or unwiring/rewiring. The modular devices use one of the docking stations inside the enclosure, with raised guide rails extending up to create a rail or slot for the devices to follow, and then be clicked into place. This design enables the guides to seat the components into place and establish an electrical contact within the chassis enclosure and the pre-installed wiring harness in the enclosure.

In addition to the ability to transfer images or color onto the curved front panel, the system may also include a flexible curved LED display module (LDM) on or part of the front panel. This feature allows information to be transmitted to the panel using management software for service or entertainment purposes.

The chassis may include charging port receiver modules on one or both sides of the unit. These ports also feature a raised channel and slot system to guide the device into place. This design allows for the use of a storage battery/flashlight or rechargeable portable speaker to be available if needed.

The battery system may be designed to be removable by the end user and used for electric mobility and any vehicle or appliance or any battery powered device such as a vehicle or an appliance that needs an external power source. Due to the modular and portable design of the batteries of the present disclosure, the users are able to access mobile power sources (disconnect and use one of the batteries) while providing continuous backup power to the primary building/structure.

The battery system may feature a front panel that can fold down and lock into a 90-degree angle when mounted vertically. This creates a sturdy and secure off-the-ground workbench for installation and service. Additionally, the top portion of the front panel can fold up to a 90-degree angle while the bottom portion folds down to a 180-degree angle, providing a sunshade for installers or technicians during the installation and maintenance process.

The system may also incorporate a large language model artificial intelligence (AI) to guide installers and technicians through the installation process in an intuitive and user-friendly manner. By scanning a QR code, users can access step-by-step instructions, enabling chatbot-based interactions and troubleshooting assistance for a seamless installation experience.

The battery system may be an innovative, environmentally friendly, and aesthetically pleasing home battery system that addresses the shortcomings of systems that came before the system of the present disclosure. With its case of installation, affordability, scalability, and IP65 rating, the residential, commercial, or marine battery system of the present disclosure offers a comprehensive solution for residential, commercial, and marine energy storage. Its unique features, such as advanced battery technology, wireless communication capabilities, modular battery replacement mechanism, energy management system, electric vehicle charging compatibility, and integrated solar inverter, make it a valuable and non-obvious improvement over current systems.

The battery system of the present disclosure may also include, in various embodiments: a transformer; a control module that features user-friendly interfaces for system monitoring and customization; thermal management systems to maintain optimal operating temperatures and ensure system longevity; a control module that supports integration with smart home systems for seamless energy management and automation; real-time data monitoring, allowing users to track energy consumption and production; built-in safety features to protect against electrical hazards and ensure secure operation; wireless communication capabilities for remote monitoring and control via mobile devices or web applications; an energy management system that optimizes battery usage based on user preferences, time-of-use rates, and grid conditions; compatibility with electric vehicle charging stations, providing an integrated solution for home energy management and electric vehicle charging; an integrated solar inverter, reducing the need for additional components and simplifying the overall system installation; a docking station inside the enclosure, with raised guide rails extending up to create a rail or slot for the devices to follow, allowing the guides to seat the components into place and establish an electrical contact within the chassis enclosure and the pre-installed wiring harness in the enclosure; a front panel that can transfer images or color and include a flexible curved LED display module (LDM) for transmitting information using management software for service or entertainment purposes; charging port receiver modules on one or both sides of the unit, featuring a raised channel and slot system to guide the device into place and allowing for the use of a storage battery/flashlight or rechargeable portable speaker when needed; a front panel that folds down and locks into a 90-degree angle when mounted vertically, creating a sturdy and secure off-the-ground workbench for installation and service; a top portion of the front panel that folds up to a 90-degree angle and provides a sunshade for installers or technicians during the installation and maintenance process; a large language model AI to guide installers and technicians through the installation process via QR code-enabled instructions, enabling chatbot-based interactions and troubleshooting assistance; allowing end users to access and replace electronic components, such as the batteries and inverters, without requiring any tools or the need to engage in electrician work.

One embodiment may be a battery system comprising: a housing; one or more covers; one or more batteries; one or more inverters; a transfer power rod; and a control module; wherein the housing comprises one or more utility bays; wherein the utility bays may be configured to receive the one or more batteries and the one or more inverters; wherein the one or more inverters may be configured to convert energy stored in the one or more batteries to alternating current (AC) power; wherein the one or more batteries may be configured to be charged by an existing power source; and wherein each of the one or more batteries may be configured to releasably engage with the transfer power rod, such that if one or more of the one or more batteries is disconnected from the transfer power rod, the other batteries of the one or more batteries that remain connected to the transfer power rod continue provide power to the one or more inverters. The existing power source may be one or more renewable power sources. The renewable power sources may be selected from the renewable power sources consisting of wind and solar. Each of the one or more covers may have an open position and a closed position, such that when the one or more covers are in the open position, the control module, the one or more inverters, and the one or more batteries are accessible. Each of the one or more batteries may comprise a battery connector, such that there may be one or more battery connectors. Each of the one or more utility bays may comprise a bay connector, such that there may be one or more bay connectors. The one or more battery connectors may be configured to matingly and removeably engage with, respectively, the one or more bay connectors. Each of the one or more batteries may have a lever that may be configured to disengage, respectively, the one or more batteries from the one or more utility bays, when actuated, such that the one or more batteries may be removed from the one or more utility bays. The transfer power rod may comprise a housing, two copper rails, and one or more connectors. Each of the one or more batteries may comprise a transfer power rod connector, such that there may be one or more transfer power rod connectors; wherein the one or more transfer power rod connectors may be configured to matingly engage with, respectively, the one or more connectors of the transfer power rod. The one or more connectors of the transfer power rod may be printed circuit board connectors that may be configured to allow power transfer within the battery system. The battery system may be electrically connected to at least one additional battery system, such that the battery system and the at least one additional battery system allow power transfer between the battery systems. The one or more batteries may be configured to engage the transfer power rod without requiring that any individual wires to be stripped and manually connected. At least one of the one or more covers hingedly engages the housing. The covers or facia may also be connected via magnets. The control module may be configured to control a plurality of operations of the battery system. The one or more utility bays may hingedly or magnetically engage the housing. The housing may further comprise a plurality of mounting holes and electrical wiring conduits; wherein the housing may be configured to be mounted to a structure. The one or more covers may be curved and made from bamboo or composite materials. The one or more covers comprise a LED screen. The one or more covers may be configured to visually match a surface of the structure.

Another embodiment may be a battery system comprising: two or more battery system units; wherein each of the two or more battery system units each comprises: a housing; one or more covers; one or more batteries; one or more inverters; a transfer power rod; and a control module; wherein the housing may comprise one or more utility bays; wherein the utility bays may be configured to receive the one or more batteries and the one or more inverters; wherein the one or more inverters may be configured to convert energy stored in the one or more batteries to alternating current (AC) power; wherein the one or more batteries may be configured to be charged by an existing power source; wherein each of the one or more batteries may be configured to releasably engage with the transfer power rod, such that if one or more of the one or more batteries may be disconnected from the transfer power rod, the other batteries of the one or more batteries that remain connected to the transfer power rod continue provide power to the one or more inverters; and wherein each of the two or more battery system units may be electrically connected to at least one other of the two or more battery system units.

Another embodiment may be battery system comprising: a housing; one or more covers; one or more batteries; one or more inverters; a transfer power rod; and a control module; wherein the housing comprises one or more utility bays; wherein the utility bays may be configured to receive the one or more batteries and the one or more inverters; wherein the one or more inverters may be configured to convert energy stored in the one or more batteries to alternating current (AC) power; wherein the one or more batteries may be configured to be charge from a renewable power source; wherein each of the one or more batteries may be configured to releasably engage with the transfer power rod, such that if one or more of the one or more batteries may be disconnected from the transfer power rod, the other batteries of the one or more batteries that remain connected to the transfer power rod continue provide power to the one or more inverters; wherein each of the one or more covers may have an open position and a closed position, such that when the one or more covers are in the open position, the control module, the one or more inverters, and the one or more batteries are accessible; wherein each of the one or more batteries may comprise a battery connector, such that there may be one or more battery connectors; wherein each of the one or more utility bays may comprise a bay connector, such that there may be one or more bay connectors; wherein the one or more battery connectors may be configured to matingly and removeably engage with, respectively, the one or more bay connectors; wherein each of the one or more batteries may have a lever that may be configured to disengage, respectively, the one or more batteries from the one or more utility bays, when actuated, such that the one or more batteries may be removed from the one or more utility bays; wherein the transfer power rod may comprise a housing, two copper rails, and one or more connectors; wherein each of the one or more batteries may comprise a transfer power rod connector, such that there may be one or more transfer power rod connectors; wherein the one or more transfer power rod connectors may be configured to matingly engage with, respectively, the one or more connectors of the transfer power rod; wherein the one or more batteries may be configured to engage the transfer power rod without requiring that any individual wires to be stripped and manually connected; and wherein the control module may be configured to control a plurality of operations of the battery system.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a battery system mounted inside a garage.

FIG. 2 is an illustration of one embodiment of a battery system on a mounting stand.

FIG. 3 is an illustration of one embodiment of a battery system with three interconnected units with contiguous front panels in a vertical configuration.

FIG. 4 is an illustration of another embodiment of a battery system with three interconnected units in a horizontal configuration.

FIG. 5 is an illustration of a rear view of one embodiment of a battery system.

FIG. 6 is an illustration of a battery system with two horizontal units blending in with the outside surface of a building.

FIG. 7 is an illustration of is an illustration of a battery system with three vertical units turned 90 degrees and blending in with the outside surface of a building.

FIG. 8 is an illustration of one embodiment of a battery system.

FIG. 9 is an illustration of a second embodiment of a battery system.

FIG. 10 is an illustration of the second embodiment of a battery system.

FIG. 11 is an illustration of one embodiment of inverters of a battery system.

FIG. 12 is an illustration of a side and rear perspective view of one embodiment of battery.

FIG. 13 is an illustration of a housing of the second embodiment of a battery system.

FIG. 14 is an illustration of a housing of another embodiment of a battery system.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, electric charge storage device or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “project owner” may refer to an individual or company, including, but not limited to, a property owner, installer, maintenance technician, contractor, device sign-in information, and/or engineer.

As used herein, the term “project type” may refer to any facet of a solar energy and/or energy storage project, including, but not limited to, installation, commissioning, inspection, maintenance and related services, warranty services, repairs and replacements, product validation, product development, training, demonstrations, sign-off, applications (use case setting, and the like), and/or fraud detection.

As used herein, the term “project goals” may refer to a goal of a solar energy and/or energy storage project, including, but not limited to, completion of the project, completion of the sign-off, impact assessment, and/or fraud detection.

As used herein, the term “project information” may include, but not be limited to: property owner information (name, address, email, phone number, site map, and the like); system design information (single line diagram (SLD), drawings, equipment list, equipment serial numbers, and the like); permit information (authority having jurisdiction (AHJ), contact persons, documentation, and the like); process information (flows for inspection, installation, commissioning, sign-off, fraud detection, training/demo, repair/replace, validation, maintenance, warranty services, product development, and the like); and/or acceptance criteria.

As used herein, the term “equipment information” may include, but not be limited to: product information (pictures, make, model, specifications, certifications, final test results, and the like); software information (versions, test results, and the like); quality information (production date, batch, alarm messages, frequent failure modules, frequent root causes, and the like); performance information (monitoring data, alarms, and the like); operations and maintenance (O&M) information (firmware update records, maintenance records, repair/replacement records, setting records, environmental records, and the like); and/or acceptance specifications (status indicators, parameters, system performance, and the like).

As used herein, the terms “impact forecast” and/or “action recommendations” may include, but not be limited to: action history; equipment performance forecast models (based on equipment information, project information, and the like); impact forecast models (on components, system performance, fraud, warranty, sign-off, usage, and the like); work instructions (install, replace, repair, commission, validate, and the like); information capture instructions (picture, video, object to capture, and the like; and/or flow instruction (such as next steps).

As used herein, the term “information capture” may include, but not be limited to, pictures, videos, texts, time stamps and GPS information, signals, documents, drawings, one or more of the project types, one or more of the project owners, one or more of the project information, action recommendations, and/or equipment information.

As used herein, the term “work actions” may include, but not be limited to, sign-in information; install, replace, repair, commission, validate, flow step, and the like.

As used herein, the term “project objects” may refer to anything related to a solar energy and/or energy storage project, including, but not limited to: photovoltaic (PV) system components (PV panel, racking, splice, end cap, roof penetration, roof clearance, sealing, flashing, cable, cable management, inter-connection, inverter, micro-inverter, optimizer, transformer, auto-transformer switch, meter, current transformer (CT), rapid shut down transmitter, rapid shut down receiver, displays screen, combiner box, circuit breaker, junction box, fuse, main panel, gateway, antenna, modem, monitoring portal display, labels, and the like); energy storage system components (battery, battery management systems (BMS), display screen, wires, critical load panel, and the like); site features (roof top, attic, rafter size, rafter span, rafter spacing, leaks, side wall, ground, trench, wiring, conduits, and the like); safety equipment (personal protective equipment (PPE), masks, gloves, face shields, arc fault face guard, signs, ladder, hand sanitizer, fall protection, and the like); and/or documentation (check list, system design, permit document, and the like).

As used herein, the term “information processing” may refer to any facet of a solar energy and/or energy storage project, including, but not limited to, image processing, text extraction, feature extraction, information classification, impact forecast refining (based on processed information, equipment information, equipment performance forecast models, impact forecast models, and the like), and/or information comparison (with acceptance criteria, project goals, and the like).

As used herein, the term “solar and energy storage projects” may refer to the construction, repair, review, and the like, of a solar energy project, an energy storage project, or both.

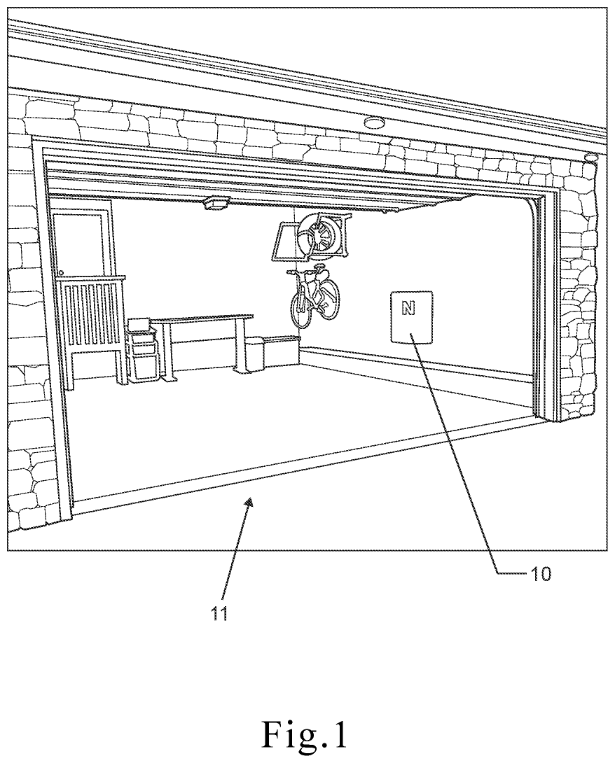

FIG. 1 is an illustration of one embodiment of a battery system mounted inside a garage. FIG. 1 shows that battery system 10 may be mounted in an attractive manner on the interior of a residential garage 11.

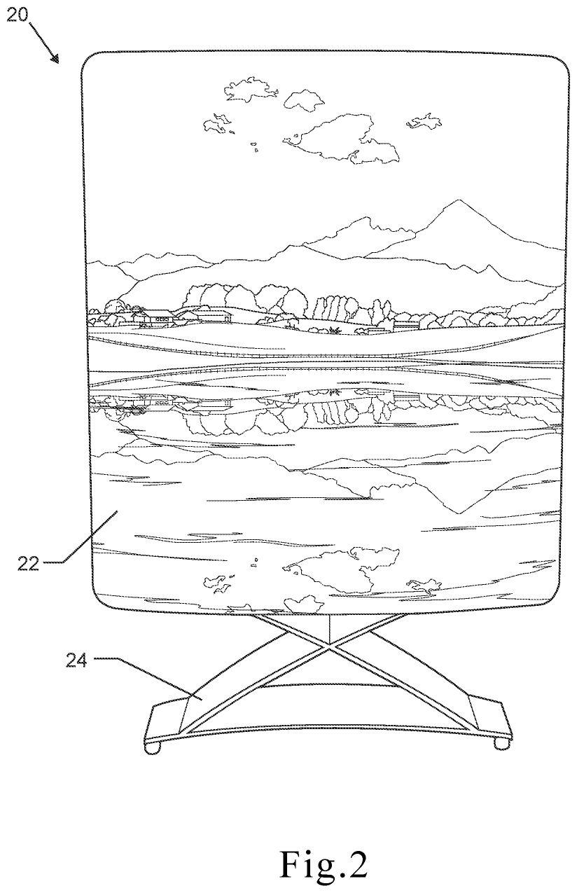

FIG. 2 is an illustration of one embodiment of a battery system on a mounting stand. FIG. 2 shows that battery system 20 of the present disclosure may have a LED display on the front cover and may be mounted on stand 24. The picture shown on the display may be any image, series of images, or streaming video. The source of the images may be saved to memory of the battery system or may be received via a cable or wireless transceiver.

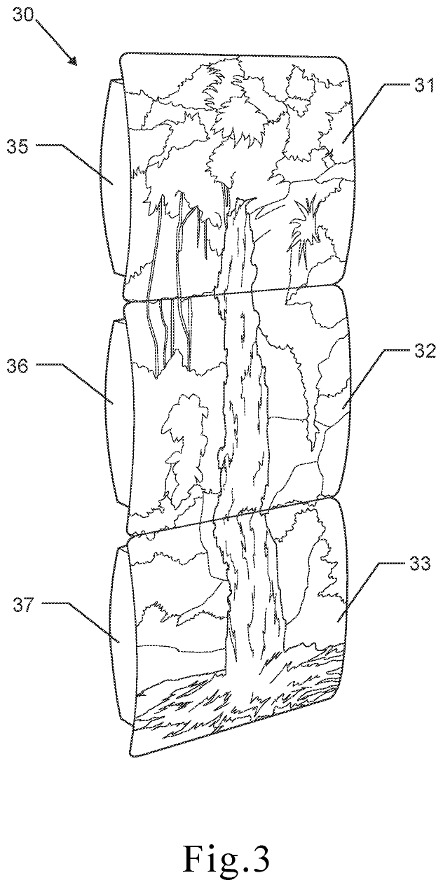

FIG. 3 is an illustration of one embodiment of a battery system with three interconnected units with contiguous front panels in a vertical configuration. FIG. 3 shows that battery system 30 may have several interconnected units 35, 36, 37, each of which may have a front cover 31, 32, 33. Front covers 31, 32, 33 may be decorated or may include an LED display. FIG. 3 shows that front covers 31, 32, 33 may be curved to allow for better cooling and attractiveness.

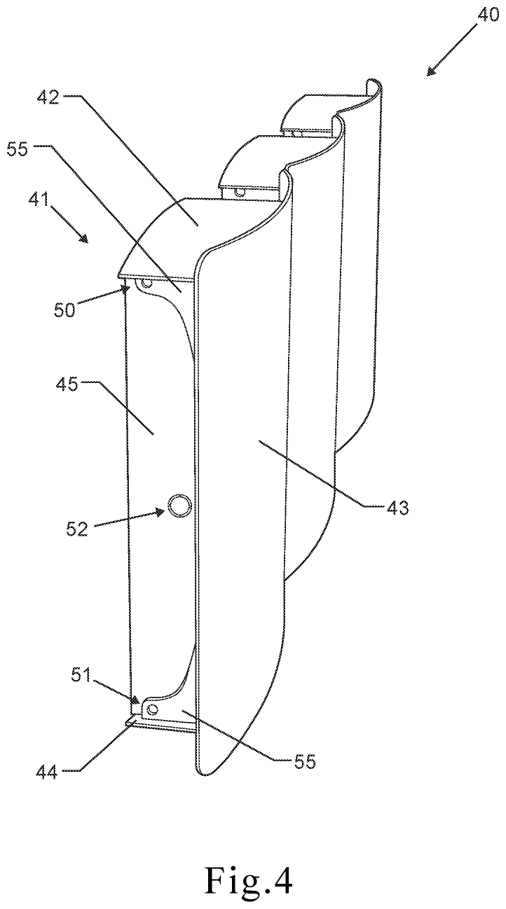

FIG. 4 is an illustration of another embodiment of a battery system with three interconnected units in a horizontal configuration. As shown in FIG. 4, battery system 40 may include three interconnected units, including unit 41. Unit 41 may include a front cover 43, top panel 42, bottom panel 44, front side panel 55, mounting bracket 45, conduit perforation 52, top connector 50, and bottom connector 51. Top connector 50 and bottom connector 51 may allow front cover 43 to be mounted onto mounting bracket 45, and then removed so the user can access the interior components. Conduit 52 may allow the units to be interconnected with wiring that is hidden by the overhang of front cover 43.

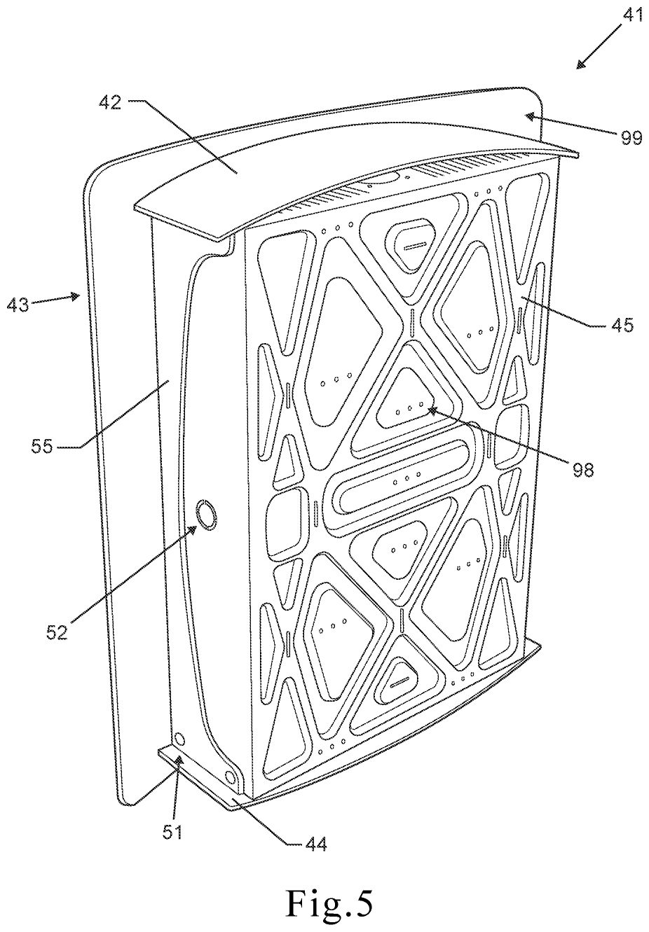

FIG. 5 is an illustration of a rear view of one embodiment of a battery system. As shown in FIG. 5, battery system unit 41 may include a front cover 43, front cover back 99, top panel 42, bottom panel 44, front side panel 55, mounting bracket 45, mounting holes 98, conduit perforation 52, top connector 50, and bottom connector 51. Top connector 50 and bottom connector 51 may allow front cover 43 to be mounted onto mounting bracket 45, and then removed so the user can access the interior components. Conduit 52 may allow the units to be interconnected with wiring that is hidden by the overhang of front cover 43.

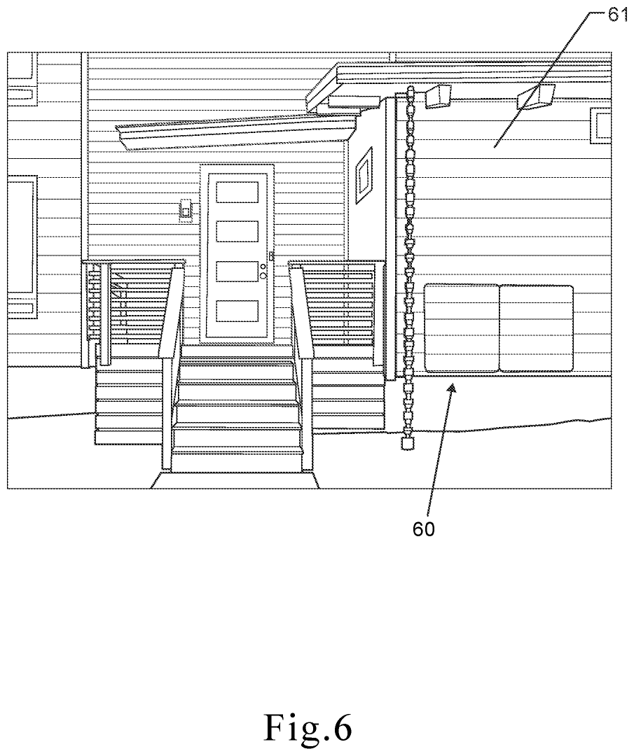

FIG. 6 is an illustration of a battery system with two horizontal units blending in with the outside surface of a building. FIG. 6 shows battery system 60 has an appearance that allows it to blend in with the siding 61 of a residential structure.

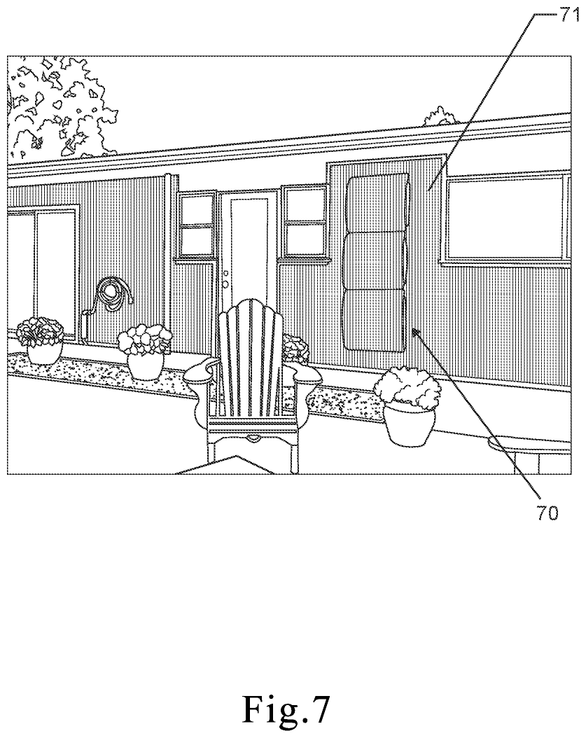

FIG. 7 is an illustration of is an illustration of a battery system with three vertical units turned 90 degrees and blending in with the outside surface of a building. FIG. 7 shows that battery system 70 may be expanded to three units that blend into structure 71.

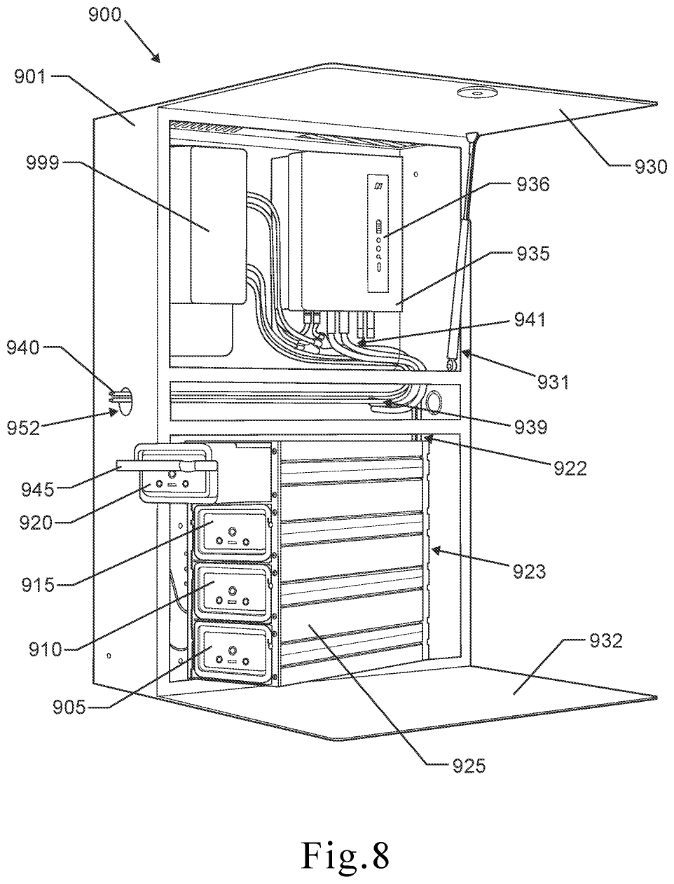

FIG. 8 is an illustration of one embodiment of a battery system. As shown in FIG. 8, battery system 900 may comprise housing 901, batteries 905, 910, 915, 920, transfer power rod 922, hinge/pivot 923, battery utility bays 925, top cover 930, top cover return 931, bottom cover 932, control module 935, which contains the inverters, status display 936, handle 945, conduit 952, wiring 939, 940, 941, a control module 935, and alternating current (AC) output 999.

Housing 901 may be a rigid structure to which the various components of the battery system 900 may engage, be contained within, and be protected from the elements. The hinge/pivot may be swapped out for a magnet attachment mechanism.

As shown, battery utility bays 925 may be located on a lower portion of the battery system 900. In alternative embodiments, the battery utility bays 925 may instead be located on an upper portion of the battery system 900, in disparate locations of the battery system, or substantially any portion of the battery system 900. As shown, battery utility bays 925 may engage the housing 901 via hinge/pivot 923, thereby allowing access to the battery utility bays 925. Specifically, a user may simply pivot the battery utility bays 925 outwards so that the batteries 905, 910, 915, 920 are accessible, and, as shown, battery 920 is in the process of being removed from or replaced back into battery utility bays 925. In alternate embodiments, the battery utility bays 925 may be static and accessible, such as by having the opening of the battery utility bays 925 facing outward.

Batteries 905, 910, 915, 920 may engage the utility bays 925 by sliding into the utility bays 925 and then being secured therein. In some embodiments, the batteries 905, 910, 915, 920 may click into place within battery utility bays 925. In some embodiments, the batteries 905, 910, 915, 920 may release from engaging the battery utility bays 925 via a quick release, lever, handle, switch, grasp, or other structure capable of engaging and disengaging.

In some embodiments, the inverters may engage battery utility bays 925, similar to how the batteries 905, 910, 915, 920 may engage battery utility bays 925. In a preferred embodiment, the inverter/s inside control module 935 may be placed in the top compartment of battery system 900 and are accessed when the top cover 930 is opened, as shown. Top cover 930 may be opened with pneumatic assistance via top cover return 931, which may also be used to prop open top cover 930, and which may also be used to soft return top cover 930 to a closed position.

Preferably, battery system 900 may be connected to the power grid and or a source of renewable energy, such as a wind turbine or solar panels/cells, which brings in power to be stored on batteries 905, 910, 915, 920 via wiring 939. The control module 935, and the inverter/s inside, may be connected to AC output 999 via wire 941, and may be connected to other units of the battery system by wiring 940 that passes through conduit 952. Batteries 905, 910, 915, 920 may be connected to the control module 935, to store and deliver power via transfer power rod 922. Transfer power rod 922 may comprise a sheathed, mostly sheathed, or unsheathed positive copper rail and a negative copper rail. Transfer power rod 922 may also comprise one or more printed circuit boards, an optional housing, and one or more connections, plugs, and/or connectors that matingly engage with connections, plugs, and/or connectors on batteries 905, 910, 915, 920. Preferably, batteries 905, 910, 915, 920 may be clicked into place with transfer power rod, such that the flow of power to (or from) batteries 905, 910, 915, 920 is uninterrupted when one or more of batteries 905, 910, 915, 920 is disengaged from transfer power rod 922 and removed from battery utility bays 925. Transfer power rod 922 may facilitate the transfer of energy from the one or more batteries 905, 910, 915, 920 through the inverter/s in control module 935, to the energy output 999 and/or wiring 940. In some embodiments, the transfer power rod 922 may be vertically mounted in housing 901.

Top cover 930 and bottom cover 932 may open to allow an individual to access the components of the battery system 900. In a preferred embodiment, a single individual may be able to open top cover 930 and bottom cover 932, which itself may be used as a shelf, as shown, when open. In this manner a single individual, without additional workforce may replace electronic components of the control module 935 and/or maintain batteries 905, 910, 915, 920. This significantly reduces the time and expense needed to repair or replace parts of battery system 900. In one embodiment, the batteries 905, 910, 915, 920 and the inverters may be housed in similar or identical electronic housings, such that the inverters and the batteries 905, 910, 915, 920, may be interchangeable in battery utility bays 925. In a preferred embodiment, transfer power rod 922 may relay commands and other electronic signals from the control module 935 to allow the engaged electronics to function as intended.

Control module 935 may be substantially similar to other control modules utilized in other known residential battery systems. In some embodiments, transfer power rod 922 may allow for electronic communication signals to be transmitted between the various electronic components and the control module 935.

Handle 945 may be used to more easily handle moving batteries 905, 910, 915, 920. In some embodiments, handle 945 may be removable from the batteries 905, 910, 915, 920. In other embodiments, handle 945 may be fixedly attached to the batteries 905, 910, 915 and the inverters. In some embodiments, handle 945 may comprise a release lever, switch, button, or other mechanism that when used allows batteries 905, 910, 915, 920 to be insertable or removeable from battery utility bays 925, such as by engaging or disengaging a physical engagement structure. In other embodiments, there may be no handle 945.

In some embodiments, the batteries not only slide in like a cassette, but they may also, optionally, pivot into being connected to the transfer power rod from the bottom of the batteries. This pivot battery system may preferably incorporate a small wheel or slide that allows the batteries to slide in from a top position or a side position. The sliding in from the side could allow the system to be configured to create a smaller physical footprint.

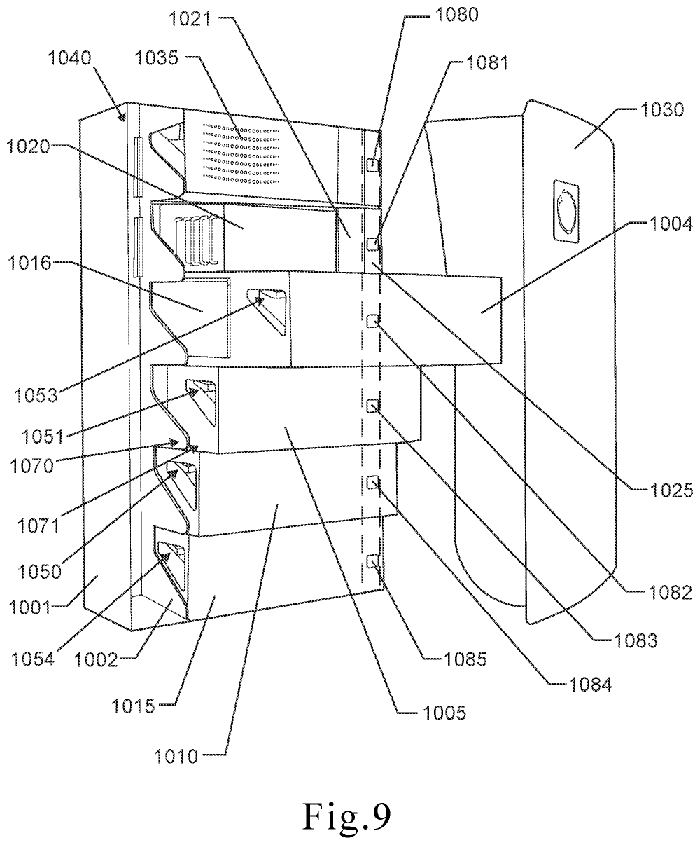

FIG. 9 is an illustration of a second embodiment of a battery system. As shown in FIG. 9, the battery system 1000 may comprise housing 1001, one or more utility bays 1002, one or more batteries 1004, 1005, 1010, 1015, one or more inverters 1020, inverter sub-bay 1021, transfer power rod 1025, connectors 1080, 1081, 1082, 1083, 1084, 1085, front cover 1030, control module 1035, extension sides 1016, levers 1050, 1051, 1053, 1054, A/C output 1040, bay connector 1070, and battery connector 1071. Housing 1001 may be a rigid structure to which the various components of the battery system 1000 may engage. Utility bays 1002 may be located on substantially any portion of the battery system 1000. As shown, utility bays 1002 may be formed from the system housing 1001 and may be accessed by removing the cover 1030. In a preferred embodiment, the utility bays 1002 may have structures configured to lock and release electronic components that are configured to engage the utility bays 1002, such as batteries 1004, 1005, 1010, 1015, inverters 1020, inverter sub-bay 1021, and control module 1035.

Batteries 1004, 1005, 1010, 1015 may engage the utility bays 1002 by sliding into the utility bays 1002 and then being releasable secured therein. In some embodiments, batteries 1004, 1005, 1010, 1015 may click into place within the utility bays 1002 via bay connector 1070 being matingly connected to battery connector 1071. In some embodiments, batteries 1004, 1005, 1010, 1015 may release from engaging the utility bays 1002 via a releasing mechanism, such as levers 1050, 1051, 1053, 1054, which may be a lever, handle, switch, button, latch, grasp, or other structure capable of engaging and disengaging via mechanical, magnetism, or friction.

In some embodiments, inverters 1020 may engage utility bays 1002 by first being inserted into sub-bay 1021, which may then be slid into and engaged with utility bays 1002 similar to how the batteries 1004, 1005, 1010, 1015 may engage the utility bays 1002. As shown in FIG. 9, battery 1004 has been disengaged from utility bays 1002. Because battery 1004 is preferably less than fifty (50) pounds, a single technician or user may remove the battery for any purpose, such as maintenance or to use the battery for another purpose. The user may then slide battery 1004 back into the appropriate bay of utility bays 1002 and then click it in place so it is held securely, but removeably in place. At the same time that battery connector of battery 1004 clicks into place with the appropriate bay connector, the back of the battery matingly engages with connector 1082 of transfer power rod 1025. In this manner, the user knows that battery 1004 is now receiving or providing power.

Transfer power rod 1025 may comprise a positive copper rail, a negative copper rail, one or more printed circuit boards, connectors 1080, 1081, 1082, 1083, 1084, 1085, and a housing, Transfer power rod 1025 may facilitate the transfer of energy from one or more batteries 1004, 1005, 1010, 1015 to inverters 1020 and to the A/C output 1040.

In some embodiments, transfer power rod 1025 may be vertically mounted in the system housing 1001. In some embodiments, a horizontal transfer power rod (or other wiring) may engage the vertically mounted transfer power rod 1025 to allow the battery system 1000 to function alongside and/or in tandem with other units of battery system 1000, and/or in tandem with separate, but connected, battery systems that may preferably be located adjacent to the battery system 1000. Other embodiments of transfer power rod 1025 may be mounted differently, such as horizontal or diagonal.

In one embodiment, the transfer power rod may be a braided copper cable. The braided copper cable transfer power rod may be flat and impregnated/encased with silicone, or a similar flexible material, almost like a belt that is able to make complex bends or curves very easily and efficiently. This type of transfer power rod may preferably incorporate the plug-in system on both ends of the braided cable, allowing users and installers to plug this into the battery system, connect to another battery system, or a separate/external accessory. This flexibility may be useful for marine or other difficult installation applications.

Cover 1030 may be removed from the system housing 1001 to allow an individual to access the components of the battery system 1000. In a preferred embodiment, a single individual may be able to remove the cover 1030 and replace electronic components, such as electronics like batteries 1004, 1005, 1010, 1015 and inverters 1020. This may have the benefit of reducing time spent on troubleshooting or repairs to the battery system 1000. In a preferred embodiment, batteries 1004, 1005, 1010, 1015 and inverters 1020 may be housed in similar or identical electronic housings, or drawers, such that inverters 1020 and batteries 1004, 1005, 1010, 1015 may be interchangeable in the utility bays 1002. In a preferred embodiment, transfer power rod 1025 may relay commands and other electronic signals to and from control module 1035 to allow the engaged electronics to function as intended.

Control module 1035 may be substantially similar to other control modules utilized in other known residential battery systems. In some embodiments, transfer power rod 1025 and other wiring may allow for electronic communication signals to be transmitted between the various electronic components and control module 1035.

Toggles, such as levers 1050, 1051, 1053, 1054, may allow batteries 1004, 1005, 1010, 1015 and inverters 1020 to releasably engage utility bays 1002. For example, batteries 1005, 1010 or their housings, may comprise the levers 1051, 1050, respectively, which when activated may physically move a locking structure to allow batteries 1005, 1010 to fixedly engage utility bays 1002, such that batteries 1005, 1010 may be inserted into or removed from the utility bays 1002 only when the levers 1050, 1051 are actuated.

In some embodiments, batteries 1004, 1005, 1010, 1015 may be similar to a drawer in functionality and allow for removal of batteries 1004, 1005, 1010, 1015 in a sliding manner. In some embodiments, levers 1050, 1051, 1053, 1054, may comprise a release lever, switch, button, or other mechanism that when used allow batteries 1005, 1010 to be insertable or removeable from utility bays 1002, such as by engaging or disengaging a physical engagement structure. In other embodiments, no levers or other types of release toggle may be required, such as with a magnet or friction system.

Preferably, the inverters 1020 are less than five (5) pounds each and preferably at least four (4) of them may be part of sub-bay 1021. In this manner, system 1000 may be scalable, starting with one battery and one inverter, and going up to four of each before another unit is needed to scale up even further. Preferably, the transfer power rod may provide 48 watts of direct current power to each bay of utility bays 1002. Preferably, the power module 1035 may automatically control (through programming) the energy assets of system 1000 to provide uninterruptable power, even if one or more of the batteries are disengaged from the transfer power rod. System 1000 may provide power from the batteries even if service or maintenance is being performed.

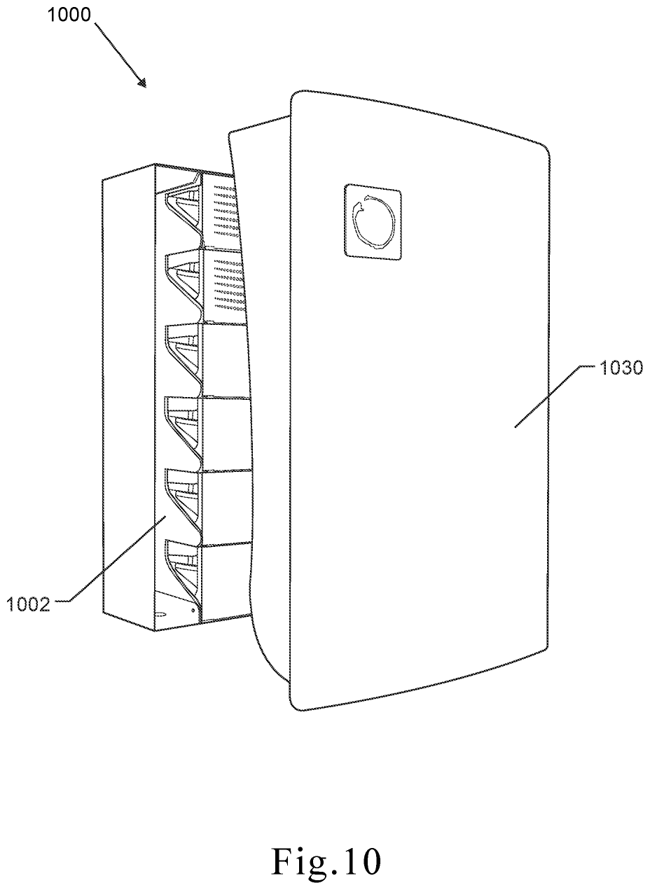

FIG. 10 is an illustration of the second embodiment of a battery system. As shown in FIG. 10 battery system 1000 may have all the internal electronics and batteries fully engaged and clicked into place in utility bays 1002.

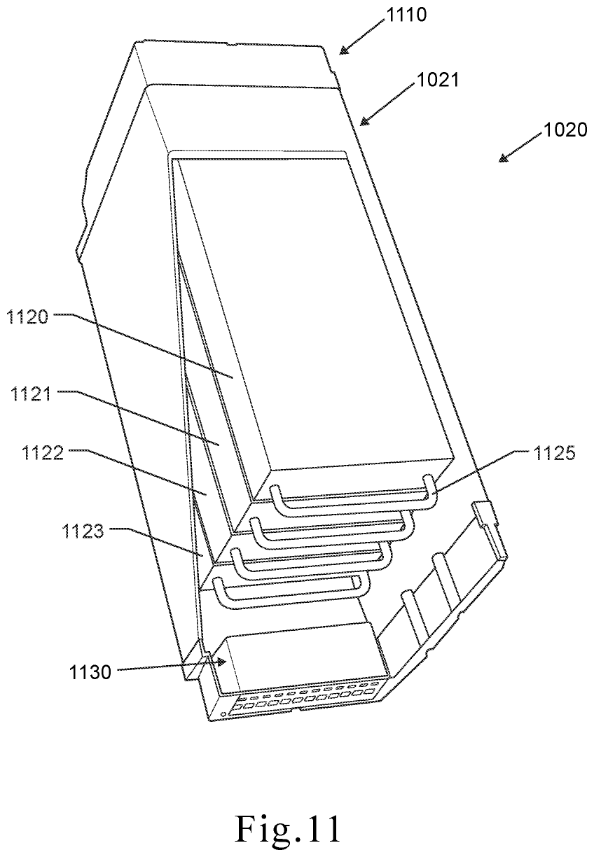

FIG. 11 is an illustration of one embodiment of inverters of a battery system. As shown in FIG. 11, in one embodiment of the battery system 1000 inverter 1020 may have four (4) inverters 1120, 1121, 1122, 1123, in a single housing, such as sub-bay 1021, which may then be inserted into a single utility bay 1002. The rear portion 1110 of sub-bay 1021 may be configured to matingly connect to transfer power rod 1025. The front portion 1130 of sub-bay 1021 of inverter 1020 may be configured to provide A/C power, with or without power module 1035, to A/C output 1040.

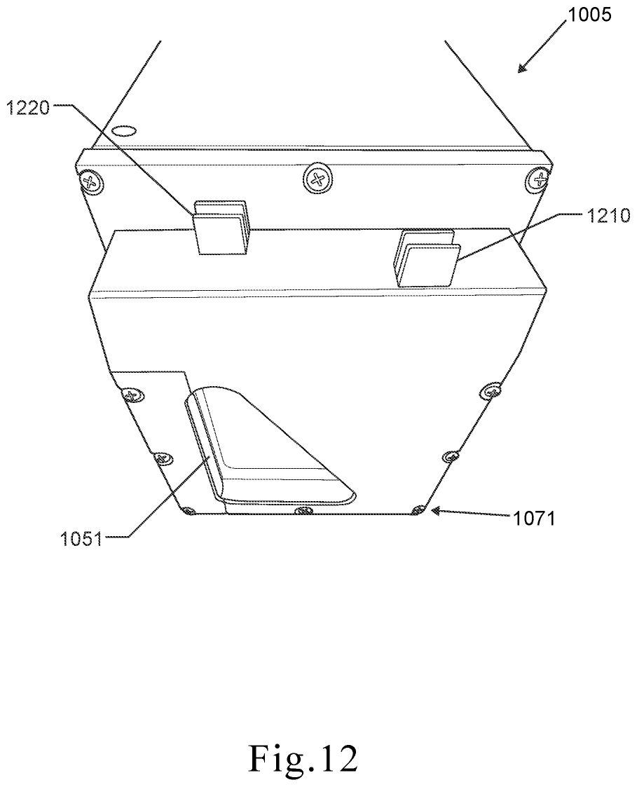

FIG. 12 is an illustration of a side and rear perspective view of one embodiment of battery. As shown in FIG. 12, battery 1005 may comprise lever 1051, battery connector 1071, and transfer power rod connectors 1210, 1220. The transfer power rod connectors 1210, 1220 may matingly engage with connectors on transfer power rod 1025, such as connector 1083.

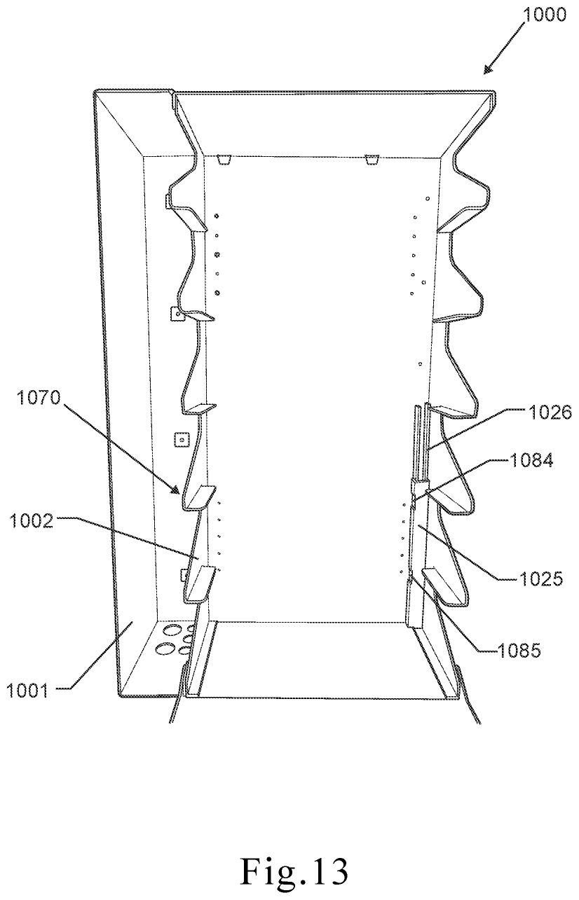

FIG. 13 is an illustration of a housing of the second embodiment of a battery system. As shown in FIG. 13, housing 1001 and utility bays 1002 of battery system 1000 are shown with no batteries, inverters, or control modules connected to utility bays 1002. Transfer power rod 1025 is partially shown, with unsheathed rods 1026, and connectors 1084, 1085. Mounting and conduit holes are shown in various places on housing 1001 to allow mounting and electrical interconnectivity to other units.

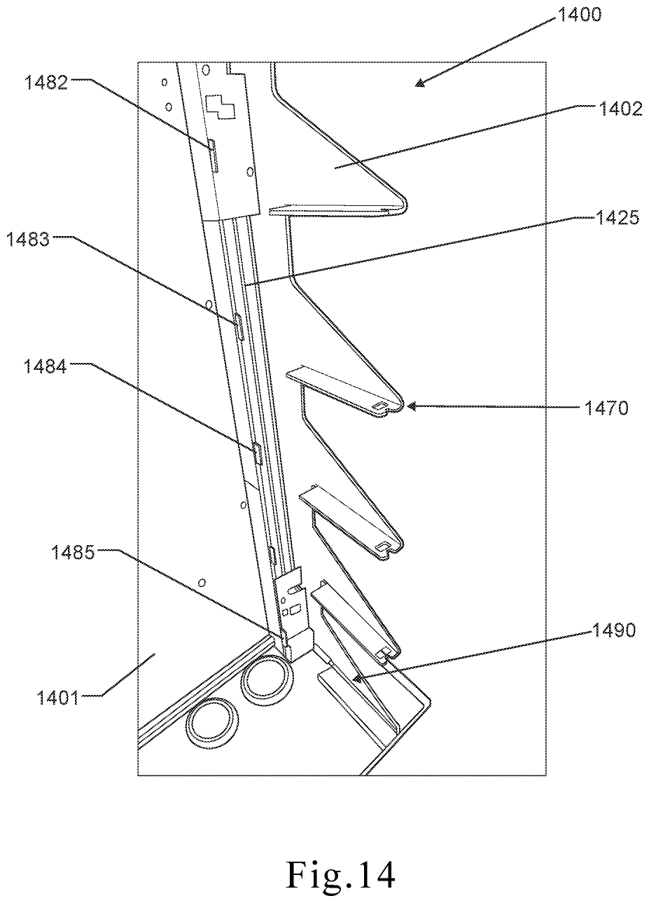

FIG. 14 is an illustration of a housing of another embodiment of a battery system. As shown in FIG. 14, system 1400 is similar to system 1000, and may include housing 1401, utility bays 1402, transfer power rod 1425, printed circuit board connectors 1482, 1483, 1483, 1485, and bay connectors 1470. Printed circuit board connectors 1482, 1483, 1483, 1485 allow the batteries to provide power and accept a charge in a programmed and controlled manner in conjunction with transfer power rod 1425. Bay connectors 1470 may be slots that matingly connect to battery connectors of batteries. FIG. 14 shows that additional rods 1490 or wiring may be connected to the bottom of transfer power rod 1425.

The systems and devices of the present disclosure have been presented in an illustrative style. The terminology employed throughout should be read in an exemplary rather than a limiting manner. While various exemplary embodiments have been shown and described, it should be apparent to one of ordinary skill in the art that there are many more embodiments that are within the scope of the devices and system of the present disclosure. Accordingly, the devices and systems of the present disclosure are not to be restricted, except in light of the appended claims and their equivalents.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A battery system comprising:
a housing;
one or more covers;
one or more batteries;
one or more inverters;
a transfer power rod; and
a control module;
wherein said housing comprises one or more utility bays;
wherein said utility bays are configured to receive said one or more batteries and said one or more inverters;
wherein said one or more inverters are configured to convert energy stored in said one or more batteries to alternating current (AC) power;
wherein said one or more batteries are configured to be charged by an existing power source; and
wherein each of said one or more batteries are configured to releasably engage with said transfer power rod, such that if one of said one or more batteries is disconnected from said transfer power rod, the other batteries of said one or more batteries that remain connected to the transfer power rod continue providing power to said one or more inverters.

2. The battery system of claim 1, wherein said existing power source is one or more renewable power sources.

3. The battery system of claim 2, wherein said one or more renewable power sources are selected from the renewable power sources consisting of wind and solar.

4. The battery system of claim 1, wherein each of said one or more covers have an open position and a closed position, such that when said one or more covers are in said open position, said control module, said one or more inverters, and said one or more batteries are accessible.

5. The battery system of claim 1, wherein each of said one or more batteries comprise a battery connector, such that there are one or more battery connectors;
wherein each of said one or more utility bays comprise a bay connector, such that there are one or more bay connectors;
wherein said one or more battery connectors are configured to matingly and removeably engage with, respectively, said one or more bay connectors.

6. The battery system of claim 5, wherein each of said one or more batteries has a lever that is configured to disengage, respectively, said one or more batteries from said one or more utility bays, when actuated, such that said one or more batteries may be removed from said one or more utility bays.

7. The battery system of claim 1, wherein said transfer power rod comprises a housing, two copper rails, and one or more connectors.

8. The battery system of claim 7, wherein each of said one or more batteries comprises a transfer power rod connector, such that there are one or more transfer power rod connectors;
wherein said one or more transfer power rod connectors are configured to matingly engage with, respectively, said one or more connectors of said transfer power rod.

9. The battery system of claim 8, wherein said one or more connectors of said transfer power rod are printed circuit board connectors that are configured to allow power transfer within said battery system.

10. The battery system of claim 9, wherein said battery system is electrically connected to at least one additional battery system, such that said battery system and said at least one additional battery system allow power transfer between said battery system and said at least one additional battery system.

11. The battery system of claim 8, wherein said one or more batteries are configured to engage said transfer power rod without requiring that any individual wires to be stripped and manually connected.

12. The battery system of claim 4, wherein at least one of said one or more covers hingedly engages said housing.

13. The battery system of claim 1, wherein said control module is configured to control a plurality of operations of said battery system.

14. The battery system of claim 1, wherein said one or more utility bays hingedly engage said housing.

15. The battery system of claim 1, wherein said housing further comprises a plurality of mounting holes and electrical wiring conduits;
wherein said housing is configured to be mounted to a structure.

16. The battery system of claim 1, wherein said one or more covers are curved and made from bamboo or composite materials.

17. The battery system of claim 1, wherein said one or more covers comprise a LED screen.

18. The battery system of claim 15, wherein said one or more covers are configured to visually match a surface of said structure.

19. A battery system comprising:
two or more battery system units;
wherein each of said two or more battery system units each comprises:
a housing;
one or more covers;
one or more batteries;
one or more inverters;
a transfer power rod; and
a control module;
wherein said housing comprises one or more utility bays;
wherein said one or more utility bays are configured to receive said one or more batteries and said one or more inverters;
wherein said one or more inverters are configured to convert energy stored in said one or more batteries to alternating current (AC) power;
wherein said one or more batteries are configured to be charged by an existing power source;
wherein each of said one or more batteries are configured to releasably engage with said transfer power rod, such that if one of said one or more batteries is disconnected from said transfer power rod, the other batteries of said one or more batteries that remain connected to the transfer power rod continue provide power to said one or more inverters; and
wherein each of said two or more battery system units is electrically connected to at least one other of said two or more battery system units.

20. A battery system comprising:
a housing;
one or more covers;
one or more batteries;
one or more inverters;
a transfer power rod; and
a control module;
wherein said housing comprises one or more utility bays;
wherein said utility bays are configured to receive said one or more batteries and said one or more inverters;
wherein said one or more inverters are configured to convert energy stored in said one or more batteries to alternating current (AC) power;
wherein said one or more batteries are configured to be charge from a renewable power source;
wherein each of said one or more batteries are configured to releasably engage with said transfer power rod, such that if one of said one or more batteries is disconnected from said transfer power rod, the other batteries of said one or more batteries that remain connected to the transfer power rod continue provide power to said one or more inverters;
wherein each of said one or more covers have an open position and a closed position, such that when said one or more covers are in said open position, said control module, said one or more inverters, and said one or more batteries are accessible;
wherein each of said one or more batteries comprise a battery connector, such that there are one or more battery connectors;
wherein each of said one or more utility bays comprise a bay connector, such that there are one or more bay connectors;
wherein said one or more battery connectors are configured to matingly and removeably engage with, respectively, said one or more bay connectors;
wherein each of said one or more batteries has a lever that is configured to disengage, respectively, said one or more batteries from said one or more utility bays, when actuated, such that said one or more batteries may be removed from said one or more utility bays;
wherein said transfer power rod comprises a housing, two copper rails, and one or more connectors;
wherein each of said one or more batteries comprises a transfer power rod connector, such that there are one or more transfer power rod connectors;
wherein said one or more transfer power rod connectors are configured to matingly engage with, respectively, said one or more connectors of said transfer power rod;
wherein said one or more batteries are configured to engage said transfer power rod without requiring that any individual wires to be stripped and manually connected; and
wherein said control module is configured to control a plurality of operations of said battery system.
